(19) United States
(12) Patent Application Publication
(10) Pub. No.: US 2019/0094610 A1
(43) Pub. Date: Mar. 28, 2019

(54) DISPLAY DEVICE

(71) Applicant: Japan Display Inc., Minato-ku (JP)

(72) Inventors: Motochika YUKAWA, Tokyo (JP); Toshiyuki HIGANO, Tokyo (JP)

(73) Assignee: Japan Display Inc., Minato-ku (JP)

(21) Appl. No.: 16/137,979

(22) Filed: Sep. 21, 2018

(30) Foreign Application Priority Data
Sep. 22, 2017 (JP) 2017-183040

(51) Int. Cl. G02F 1/1335; G02F 1/1337; G02F 1/1333

(52) U.S. Cl. CPC G02F 1/133528; G02F 1/133514; G02F 1/133512; G02F 1/133723; G02F 2202/28; G02F 1/133305; G02F 1/133602; G02F 2001/133519; G02F 1/133308

(57) ABSTRACT

According to one embodiment, a display device includes a display panel including a first flat portion, and a bend portion adjacent to the first flat portion, and a first optical film including a first polarizing layer, the first optical film including a first portion overlapping the first flat portion, and a second portion overlapping the bend portion, a first thickness of the first portion being different from a second thickness of the second portion.

### CROSS-REFERENCE TO RELATED APPLICATIONS

This application is based upon and claims the benefit of priority from Japanese Patent Application No. 2017-183040, filed Sep. 22, 2017, the entire contents of which are incorporated herein by reference.

### FIELD

Embodiments described herein relate generally to a display device.

### BACKGROUND

Display devices such as a liquid crystal display device and an organic electroluminescent display device comprise a display area which displays an image, and a non-display area around the display area. In the non-display area, various circuits for driving pixels are arranged. Also, a sealant for bonding together a pair of substrates is arranged in the non-display area. Recently, technologies for narrowing a frame of a display device have been considered variously.

In bonding a display panel and a polarizer to each other, a state in which an end portion of the polarizer overlaps the display area, or protrudes from the display panel is not desirable. Accordingly, in accordance with narrowing of the frame, a high level of accuracy is required in the alignment of the polarizer with the display panel.

For example, a technology of bonding the polarizer in such a way that it is protruded from at least one end of a liquid crystal panel, and cutting a portion of the polarizer protruding from the liquid crystal panel by using a laser beam is known.

### BRIEF DESCRIPTION OF THE DRAWINGS

FIG. 1 is a plan view showing the structure of a display device DSP of the present embodiment.

FIG. 2 is a cross-sectional view showing the display device DSP taken along line A-B of FIG. 1.

FIG. 3 is an illustration for explaining the state in which the display device DSP is bent along bend lines BL1 and BL2.

FIG. 4 is an illustration for explaining the state in which the display device DSP is bent along bend lines BL3 and BL4.

FIG. 5 is a perspective view showing the display device DSP bent along the bend line BL1.

FIG. 6 is an illustration showing a first optical film OF1 and a second optical film OF2 applicable when bending the display device DSP along the bend lines BL1 and BL2 shown in FIG. 3.

FIG. 7 is an illustration showing the first optical film OF1 and the second optical film OF2 applicable when bending the display device DSP along the bend lines BL3 and BL4 shown in FIG. 4.

FIG. 8 is a cross-sectional view showing another configuration example of the display device DSP.

FIG. 9 is a cross-sectional view showing yet another configuration example of the display device DSP.

FIG. 10 is a cross-sectional view showing yet another configuration example of the display device DSP.

FIG. 11 is a cross-sectional view showing yet another configuration example of the display device DSP.

FIG. 12 is an illustration showing the structure of the display device DSP.

FIG. 13 is a cross-sectional view showing a configuration example of a pixel PX.

FIG. 14 is a cross-sectional view showing the state in which the first optical film OF1 and the second optical film OF2 are bent by 90 degrees together with a display panel PNL.

FIG. 15 is a cross-sectional view showing a formation example of a groove GR1.

FIG. 16 is a cross-sectional view showing another formation example of the groove GR1.

FIG. 17 is a cross-sectional view showing a formation example of the grooves GR1 and GR2.

FIG. 18 is a cross-sectional view showing another formation example of the grooves GR1 and GR2.

FIG. 19 is a cross-sectional view showing yet another formation example of the grooves GR1 and GR2.

FIG. 20 is a cross-sectional view showing yet another formation example of the grooves GR1 and GR2.

FIG. 21 is a cross-sectional view showing yet another formation example of the grooves GR1 and GR2.

FIG. 22 is an illustration showing an example of a shape of the groove GR1.

FIG. 23 is an illustration showing another example of the shape of the groove GR1.

FIG. 24 is an illustration showing another cross section of the first optical film OF1 comprising the groove GR1.

### DETAILED DESCRIPTION

In general, according to one embodiment, a display device includes: a display panel including a first flat portion, and a bend portion adjacent to the first flat portion; and a first optical film including a first polarizing layer, the first, optical film including a first portion overlapping the first flat portion, and a second portion overlapping the bend portion, a first thickness of the first portion being different from a second thickness of the second portion.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, rather than as an accurate representation of what is implemented. However, such schematic illustration is merely exemplary, and in no way restricts the interpretation of the invention. In addition, in the specification and drawings, structural elements which function in the same or similar manner to those described in connection with the preceding drawings are denoted by like reference numbers, and detailed explanations of them considered redundant may be omitted.

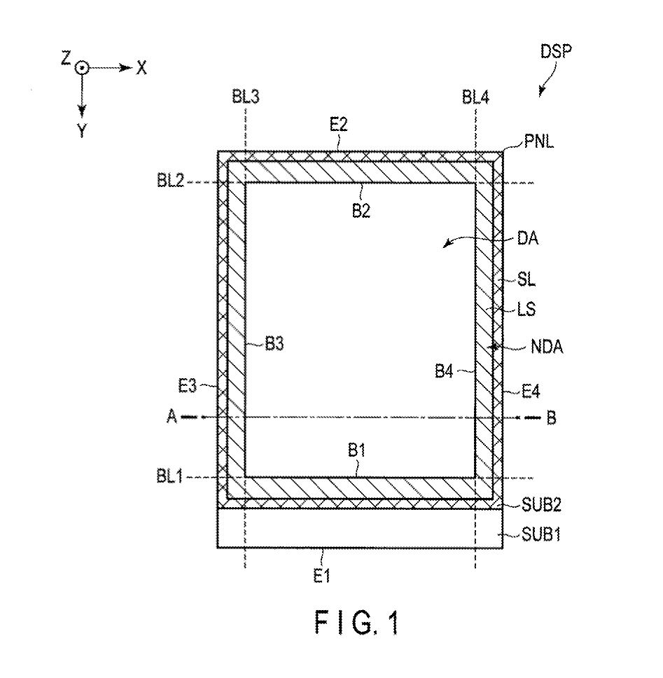

FIG. 1 is a plan view showing the structure of a display device DSP of the present embodiment. While a first direction X, a second direction Y, and a third direction Z in the figure are orthogonal to each other, they nay cross each other at an angle other than 90 degrees. The first direction X and the second direction Y correspond to directions parallel to a main surface of a substrate which constitutes the display device DSP, and the third direction Z corresponds to a thickness direction of the display device DSP. In the following explanation, a direction toward a side indicated by a pointing end of an arrow corresponding to the third direction Z is referred to as upper, and a direction toward the opposite side from the pointing end of the arrow is referred to as lower. When such expressions as “a second member above a first member” and “a second member below a first member” are used, the second member may be in contact with the first member or may be separated from the first member. Further, viewing an X-Y plane defined by the first direction X and the second direction Y from the pointing end side of the arrow indicating the third direction Z is called a planar view.

The display device DSP comprises a display panel PNL. The display panel PNL is, for example, a liquid crystal panel, and includes a first substrate SUB1, a second substrate SUB2, and a liquid crystal layer (a liquid crystal layer LC which will be described later). The first substrate SUB1 and the second substrate SUB2 are opposed to each other in the third direction Z, and are bonded to each other by a sealant SL.

The display device DSP includes a display area DA in which an image is displayed, and a non-display area NDA around the display area DA. The non-display area NDA is formed in a frame shape. The sealant SL is located in the non-display area NDA. The display area DA is surrounded by a light-shielding layer LS provided in the second substrate SUB2. The sealant SL overlaps the light-shielding layer LS as seen in plan view. In FIG. 1, the sealant SL is represented by upward-sloping hatch lines, and the light-shielding layer LS is represented by downward-sloping hatch lines.

The display device DSP includes sides E1 and E2 extending along the first direction X, and sides E3 and E4 extending along the second direction Y. In one example, the sides E1 and E2 correspond to short sides, and the sides E3 and E4 correspond to long sides. The first substrate SUB1 and the second substrate SUB2 are formed of a flexible material. Accordingly, the display device DSP can be bent along bend lines BL1 and BL2 along the first direction X. Alternatively, the display device DSP can be bent along bend lines BL3 and BL4 along the second direction Y.

Each of the bend lines BL1 to BL4 is located between the display area DA and corresponding side of the sides E1 to E4. The bend lines BL1 to BL4 all extend linearly. In the example illustrated, the bend lines BL1 to BL4 are located at boundaries B1 to B4, respectively, which are between the display area DA and the non-display area NDA. The boundaries B1 and B2 correspond to straight portions along the first direction X, and the boundaries B3 and B4 correspond to straight portions along the second direction Y.

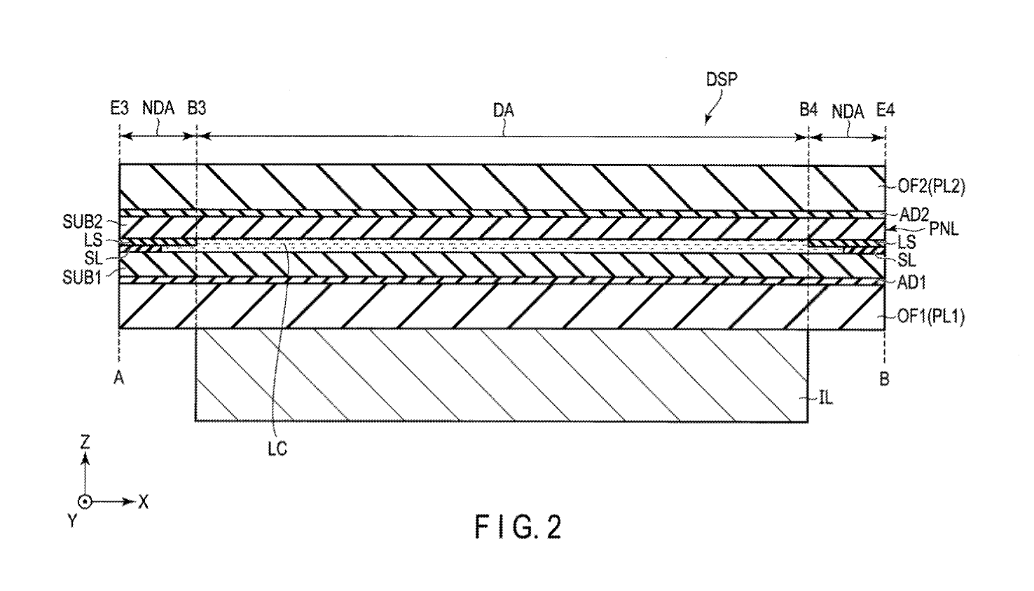

FIG. 2 is a cross-sectional view showing the display device DSP taken along line A-B of FIG. 1. The display device DSP comprises a first optical film OF1, a second optical film OF2, an adhesive layer AD1 interposed between the display panel PNL and the first optical film OF1, an adhesive layer AD2 interposed between the display panel PNL and the second optical film OF2, and an illumination device IL, in addition to the display panel PNL shown in FIG. 1.

The first optical film OF1 includes a first polarizing layer PL1, and is bonded to the first substrate SUB1 by the adhesive layer AD1. The second optical film OF2 includes a second polarizing layer PL2, and is bonded to the second substrate SUB2 by the adhesive layer AD2. The first optical film OF1 and the second optical film OF2 are disposed in not only the display area DA, but also the non-display area NDA. In the example illustrated, the first optical film OF1 and the second optical film OF2 are extended to the sides E3 and E4. While the first optical film OF1 and the second optical film OF2 each have a basic structure in which a polarizing layer is held between a pair of support bodies, as will be described later, they may include the other optical function layer such as a retardation layer.

The light-shielding layer LS is disposed between the side E3 and the boundary B3, and between the side E4 and the boundary B4. The sealant SL is arranged at sides close to the sides E3 and E4 in the non-display area NDA. The liquid crystal layer LC is hold between the first substrate SUB1 and the second substrate SUB2 within the sealant SL. The liquid crystal layer LC is also interposed between the light-shielding layer LS and the first substrate SUB1 in the non-display area NDA.

The illumination device IL is located under the first optical film OF1, and illuminates the display panel PNL. The illumination device IL is disposed in at least the display area DA, and may be arranged in the non-display area NDA. The illumination device IL may be bonded to the first optical film OF1.

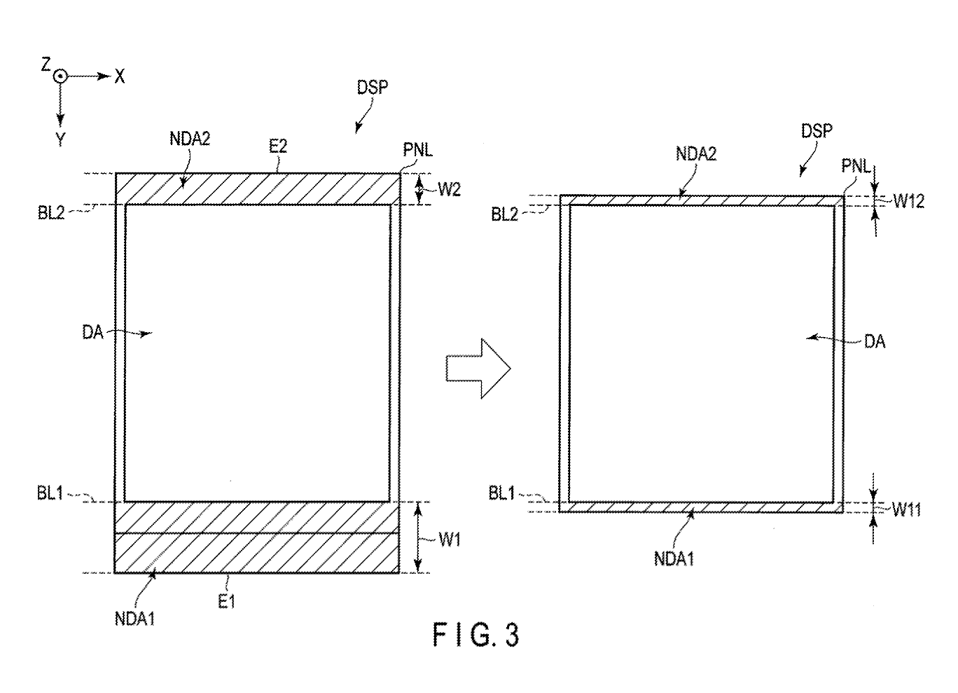

FIG. 3 is an illustration for explaining the state in which the display device DSP is bent along the bend lines BL1 and BL2. A plan view on the left side of the figure shows the display device DSP before it is bent. The display device DSP comprises a non-display area NDA1 and a non-display area NDA2 extending along the first direction X, as the non-display areas. The non-display area NDA1 is located between the side E1 and the display area DA, and has a frame width W1 along the second direction Y. The non-display area NDA2 is located between the side E2 and the display area DA, and has a frame width W2 along the second direction T.

A plan view on the right side of the figure shows the display device DSP bent along the bead lines BL1 and BL2. The illustrated display device DSP is bent in such a way that the sides E1 and E2 shown in the left plan view are located under the display area DA. As seen in plan view, the non-display area NDA1 has a frame width W11 less than the frame width W1 along the second direction Y. Similarly, the non-display area NDA2 has a frame width W12 less than the frame width W2 along the second direction Y. Accordingly, narrowing of the frame is enabled in the display device DSP which is bent in this way as compared to that before being bent.

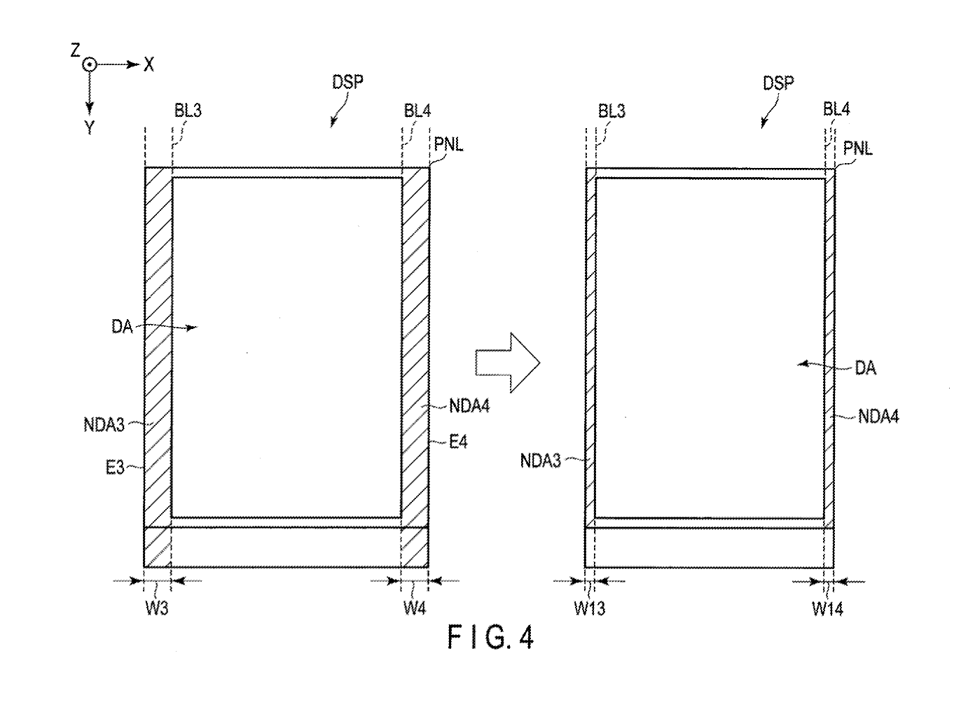

FIG. 4 is an illustration for explaining the state in which the display device DSP is bent along the bend lines BL3 and BL4. A plan view on the left side of the figure shows the display device DSP before it is bent. The display device DSP comprises a non-display area NDA3 and a non-display area NDA4 extending along the second direction Y, as the non-display areas. The non-display area NDA3 is located between the side E3 and the display area DA, and has a frame width W3 along the first direction X. The non-display area NDA4 is located between the side E4 and the display area DA, and has a frame width W4 along the first direction X.

A plan view on the right side of the figure shows the display device DSP bent along the bend lines BL3 and BL4. The illustrated display device DSP is bent in such a way that the sides E3 and E4 shown in the left plan view are located under the display area DA. As seen in plan view, the non-display area NDA3 has a frame width W13 loss than the frame width W3 along the first direction X. Similarly, the non-display area NDA4 has a frame width W14 less than the width W4 along the first direction X. Accordingly, narrowing of the frame is enabled in the display device DSP which is bent in this way as compared to that before being bent.

Next, the display device DSP bent along any one of the above bend lines BL1 to BL4 will be explained. As an example, a configuration example in which the display device DSP is bent along the bend line BL1 will be explained. However, the same applies to a case where the display device DSP is bent along the other bend lines.

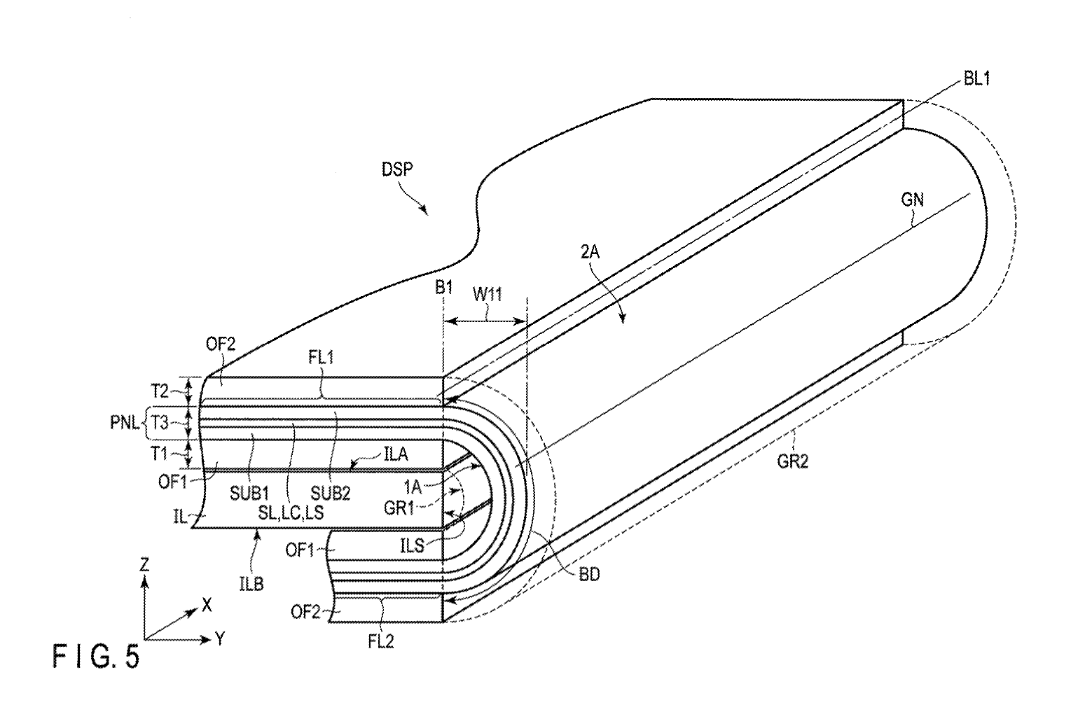

FIG. 5 is a perspective view showing the display device DSP bent along the bend line BL1. The display panel PNL comprises a first flat portion FL1, a bend portion BD, and a second flat portion FL2. The bend portion BD is adjacent to the first flat portion FL1, and the second flat portion FL2 is adjacent to the bend portion BD. In the display device DSP which is bent at the bend portion BD, the first flat portion FL1 and the second flat portion FL2 are opposed to each other in the third direction Z, and the first flat portion FL1 is located above the second flat portion FL2.

In the bend portion BD, the first substrate SUB1 is located on an inner circumferential side, and the second substrate SUB2 is located on an outer circumferential side. A lower surface 1A of the first substrate SUB1 corresponds to an inner circumferential surface of the bend portion BD, and an upper surface 2A of the second substrate SUB2 corresponds to an outer circumferential surface of the bend portion BD. The lower surface 1A and the upper surface 2A are both curved surfaces, and are cylindrical surfaces in the example illustrated. A radius of curvature of the lower surface 1A is smaller than a radius of curvature of the upper surface 2A. The bend portion BD is formed in a cylindrical shape, and a generator GN of the bend portion BD is along the bend line BL1. The generator GN and the bend line BL1 are both along the first direction X.

The first optical film OF1 is bonded to the first substrate SUB1 at each of the first flat portion FL1 and the second flat portion FL2. Further, the first optical film OF1 comprises a groove GR1 overlapping the bend portion BD. In the example illustrated, the groove GR1 penetrates through the first optical film OF1. Accordingly, a thickness of the display device DSP at the bend portion BD is less than that at the first flat portion FL1 by a thickness of the first optical film OF1. The first optical film OF1 is not arranged on the inner circumferential side of the bend portion BD as shown by a dotted line in the figure. In other words, the groove GR1 is located on the inner circumferential side of the bend portion BD. The second optical film OF2 is bonded to the second substrate SUB2 at each of the first flat portion FL1 and the second flat portion FL2. Further, the second optical film OF2 comprises a groove GR2 overlapping the bend portion BD. In the example illustrated, the groove GR2 penetrates through the second optical film OF2. Accordingly, at the bend portion BD, the thickness of the display device DSP is equal to a thickness of the display panel PNL. The second optical film OF2 is not arranged on the outer circumferential side of the bend portion BD as shown by a dotted line in the figure. In other words, the groove GR2 is located on the outer circumferential side of the bend portion BD. The groove GR1 and the groove GR2 are formed along the bend line BL1 or the generator GN.

The illumination device IL is located between the first flat portion FL1 and the second flat portion FL2. In the example illustrated, the first optical film OF1 is interposed between the first flat portion FL1 and the illumination device IL, and between the second flat portion FL2 and the illumination device IL. The first optical film OF1 may be bonded to each of an upper surface ILA and a lower surface ILB of the illumination device IL. A side surface ILS of the illumination device IL is opposed to the display panel PNL via the groove GR1. The lower surface 1A of the first substrate SUB1 may be in contact with the side surface ILS.

When the bend line BL1 matches with the boundary B1 shown in FIG. 1, the bend portion BD is located in the non-display area NDA1 shown in FIG. 3. The frame width W11 of the non-display area STA1 corresponds to a length between the boundary B1 and the upper surface (outer circumferential surface) 2A, which is most distant from the first flat portion FL1, along the second direction Y. The frame width W11 as described above is less than a total sum of a thickness T1 of the first optical film OF1, a thickness T2 of the second optical film OF2, and a thickness T3 of the display panel PNL. Also, since the groove GR1 of the first optical film OF1 overlaps the bend portion BD, the lower surface (inner circumferential surface) 1A can be brought near to the side surface ILS of the illumination device IL via the groove GR1. When a distance between the lower surface 1A and the side surface ILS along the second direction Y is less than the thickness T1 of the first optical film OF1, the frame width W11 is less than a total sum of the thickness T1 of the first optical film OF1 and the thickness T3 of the display panel PNL. When the lower surface 1A is in contact with the side surface ILS, the frame width W11 becomes equal to the thickness T3 of the display panel PNL.

Further, since the first optical film OF1 and the second optical film OF2 whose rigidity is greater than that of the display panel PNL comprise the grooves GR1 and GR2 overlapping the bend portion BD of the display panel PNL, respectively, the display panel PNL can be bent easily. Further, the display panel PNL can be bent with a smaller radius of curvature.

Consequently, narrowing of the frame of the display device DSP is enabled.

Next, the first optical film OF1 and the second optical film OF2 that are suitable in bending the display device DSP will be explained.

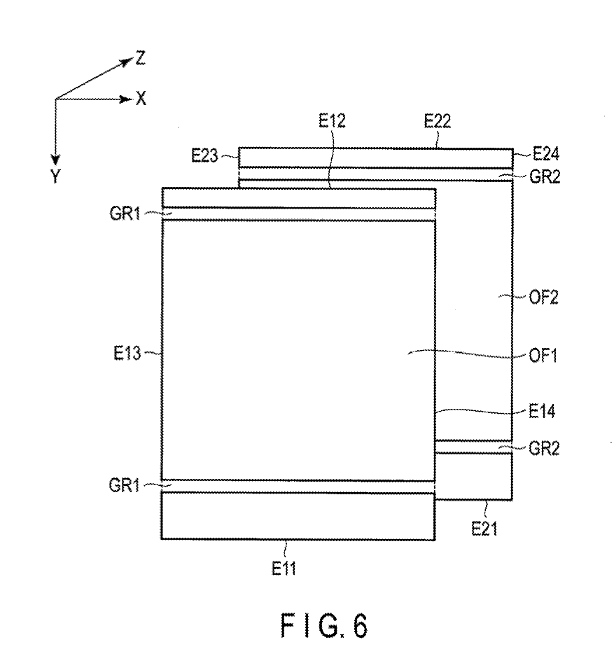

FIG. 6 is an illustration showing the first optical film OF1 and the second optical film OF2 applicable in bending the display device DSP along the bend lines BL1 and BL2 shown in FIG. 3. The first optical film OF1 comprises edges E13 and E14 opposed to each other. The groove GR1 extends along the first direction X, and is formed continuously from the edge E13 to the edge E14. Similarly, the second optical film OF2 comprises edges E23 and E24 opposed to each other. The groove GR2 extends along the first direction X, and is formed continuously from the edge E23 to the edge E24. The grooves GR1 and GR2 are located in the non-display areas NDA1 and NDA2 shown in FIG. 3, and are formed linearly. In the example illustrated in FIG. 6, the edge E23 corresponds to a first edge, and the edge E24 corresponds to a second edge. The grooves GR1 and GR2 illustrated in the drawing are formed along the short sides of the display device DSP shown in FIG. 1, respectively.

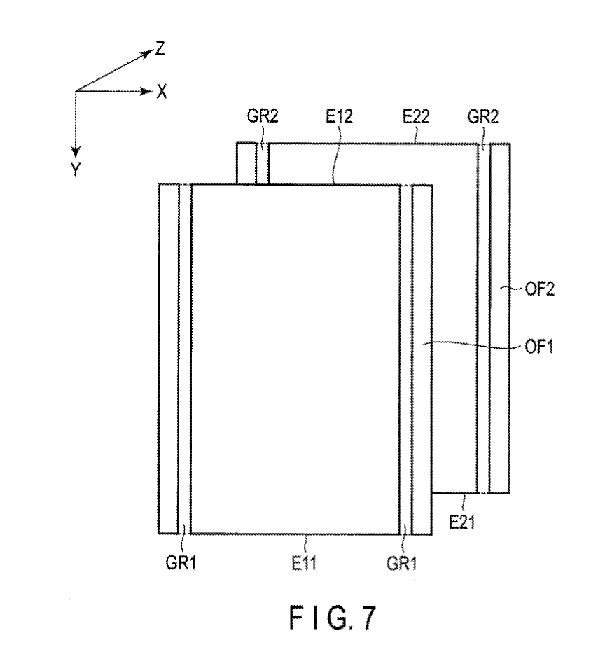

FIG. 7 is an illustration showing the first optical film OF1 and the second optical film OF2 applicable in bending the display device DSP along the bend lines BL3 and BL4 shown in FIG. 4. The first optical film OF1 comprises edges E11 and E12 opposed to each other. The groove GR1 extends along the second direction Y, and is formed continuously from the edge E11 to the edge E12. Similarly, the second optical film OF2 comprises edges E21 and E22 opposed to each other. The groove GR2 extends along the second direction Y, and is formed continuously from the edge E21 to the edge E22. The grooves GR1 and GR2 are located in the non-display areas NDA3 and NDA4 shown in FIG. 4, and are formed linearly. In the example illustrated in FIG. 7, the edge E21 corresponds to the first edge, and the edge E22 corresponds to the second edge. The grooves GR1 and GR2 illustrated in the drawing are formed along the long sides of the display device DSP shown in FIG. 1, respectively.

Next, another configuration example of the display device DSP will be described. As another configuration example which will be explained below, the display device DSP bent along the bend line BL1 as in the configuration example shown in FIG. 5 will be explained.

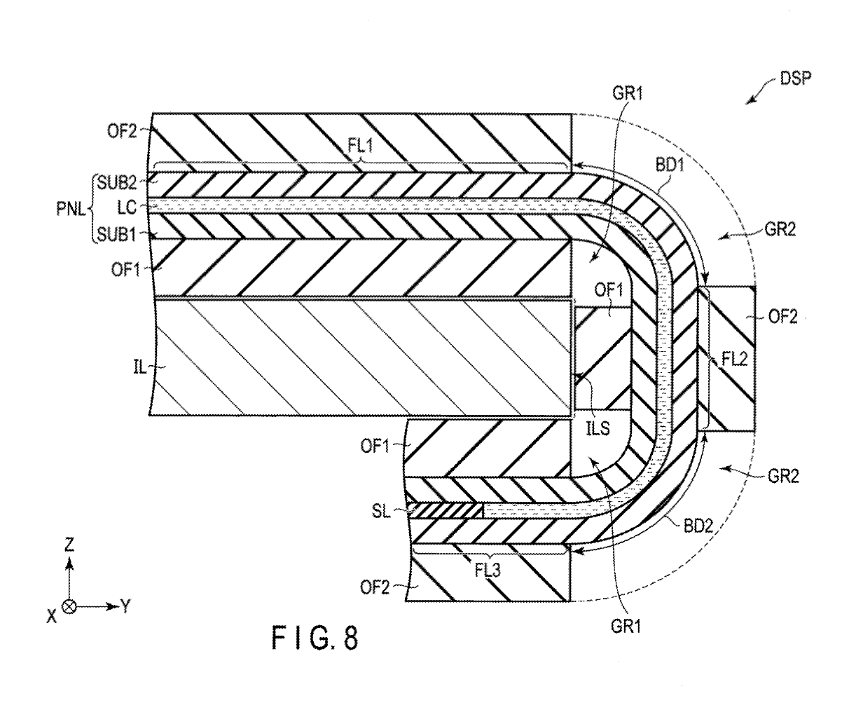

FIG. 8 is a cross-sectional view showing another configuration example of the display device DSP. The configuration example shown in FIG. 8 is different from the configuration example shown in FIG. 5 in that the display panel PNL comprises first to third flat portions FL1 to FL3, and first and second bend portions BD1 and BD2. The first bend portion BD1 is located between the first flat portion FL1 and the second flat portion FL2, and the second bend portion BD2 is located between the second flat portion FL2 and the third flat portion FL3. In the display device DSP bent at the first and second bend portions BD1 and BD2, the first flat portion FL1 and the third flat portion FL3 are opposed to each other in the third direction Z, and the first flat portion FL1 is located above the third flat portion FL3.

The first optical film OF1 is bonded to the first substrate SUB1 at each of the first to third flat portions FL1 to FL3. Also, the first optical film OF1 comprises the grooves GR1 overlapping the first and second bend portions BD1 and BD2, respectively. Similarly, the second optical film OF2 is bonded to the second substrate SUB2 at each of the first to third flat portions FL1 to FL3. Also, the second optical film OF2 comprises the grooves GR2 overlapping the first and second bond portions BD1 and BD2, respectively. It suffices that at least one of the first optical film OF1 and the second optical film OF2 is bonded to the second flat portion FL2.

The illumination device IL is located between the first flat portion FL1 and the third flat portion FL3. The first optical film OF1 is interposed between the first flat portion FL1 and the illumination device IL, and between the third flat portion FL3 and the illumination device IL. The side surface ILS of the illumination device IL is opposed to the second flat portion FL2 via the first optical film OF1.

Also in this configuration example, the same advantage as that of the above-described configuration example can be obtained. In addition, since at least one of the first optical film OF1 and the second optical film OF2 is bonded to the second flat portion FL2, the display panel PNL can be reinforced.

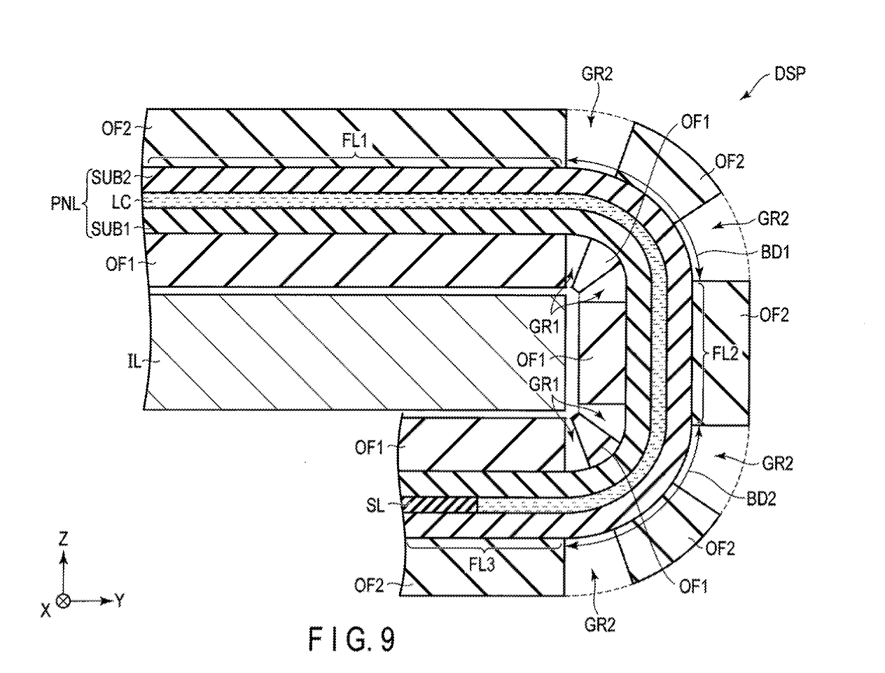

FIG. 9 is a cross-sectional view showing yet another configuration example of the display device DSP. The configuration example shown in FIG. 9 is different from the configuration example shown in FIG. 8 in that the first optical film OF1 and the second optical film OF2 are partly bonded to the first and second bend portions BD1 and BD2. In other words, the grooves GR1 and GR2 overlap the first and second bend portions BD1 and BD2 partly. More specifically, the first optical film OF1 is also bonded to a part of the first bend portion BD1, and includes a plurality of grooves GR1 overlapping the first bend portion BD1. Also, the first optical film OF1 is bonded to a part of the second bend portion BD2, and includes a plurality of grooves GR1 overlapping the second bend portion BD2. Similarly, the second optical film OF2 includes a plurality of grooves GR2 overlapping each of the first bend portion BD1 and the second bend portion BD2.

Also in this configuration example, the same advantage as that of the above-described configuration example can be obtained. In addition, since at least one of the first optical film OF1 and the second optical film OF2 is bonded to the first and second bend portions BD1 and BD2, the display panel PNL can be reinforced.

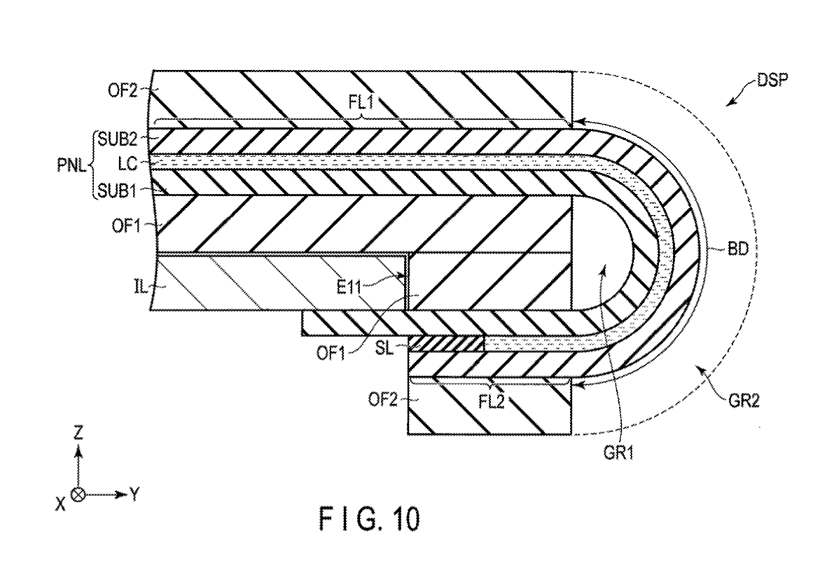

FIG. 10 is a cross-sectional view showing yet another configuration example of the display device DSP. The configuration example shown in FIG. 10 is different from the configuration example shown in FIG. 5 in that the first optical films OF1 overlapping the first flat portion FL1 and the second flat portion FL2, respectively, are opposed to each other in the third direction Z without interposition of the illumination device IL. The illumination device IL and the edge E11 of the first optical film OF1 are opposed to each other in the second direction Y. The grooves GR1 and GR2 overlap the bend portion BD entirely. In the example illustrated, for a single bend portion BD, a single groove GR1 is provided, and a single groove GR2 is provided.

Also in this configuration example, the same advantage as that of the above-described configuration example can be obtained. In addition, as compared to the configuration example illustrated in FIG. 5, the thickness of the display device DSP along the third direction Z can be reduced.

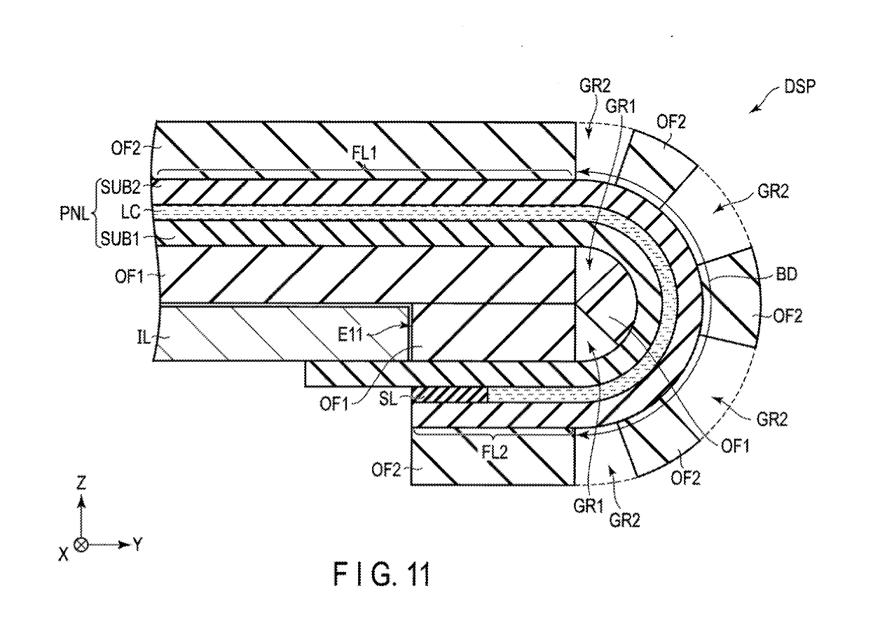

FIG. 11 is a cross-sectional view showing yet another configuration example of the display device DSP. The configuration example shown in FIG. 11 is different from the configuration example shown in FIG. 9 in that the first optical films OF1 overlapping the first flat portion FL1 and the second flat portion FL2, respectively, are opposed to each other in the third direction Z without interposition of the illumination device IL. The illumination device IL and the edge E11 of the first optical film OF1 are opposed to each other in the second direction Y. The grooves GR1 and GR2 overlap the bend portion BD partly. In the example illustrated, for a single bend portion BD, a plurality of grooves GR1 are provided, and a plurality of grooves GR2 are provided.

Also in this configuration example, the same advantage as that of the above-described configuration example can be obtained. In addition, as compared to the configuration example illustrated in FIG. 9, the thickness of the display device DSP along the third direction Z can be reduced.

Next, a liquid crystal display device, which is an example of the display device DSP, will be explained in more detail.

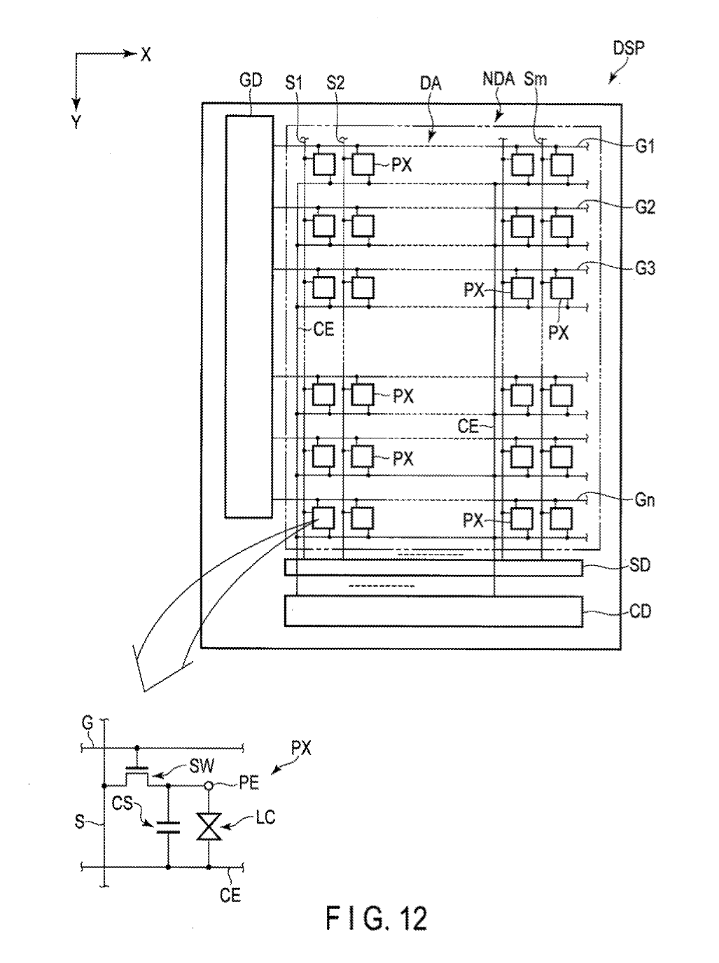

FIG. 12 is an illustration showing the structure of the display device DSP. The display device DSP includes, in the display area DA, pixels PX, scanning lines G (G1 to Gn), signal lines S (S1 to Sm), and a common electrode CE. The pixels PX are arrayed in a matrix. Each of the scanning lines G extends in the first direction X, and is connected to a scanning line drive circuit GD. Each of the signal lines S extends in the second direction Y, and is connected to a signal line drive circuit SD. The common electrode CE is arranged over the pixels PX, and is connected to a common electrode drive circuit CD.

Each of the pixels PX comprises a switching element SW, a pixel electrode PE, the common electrode CE, the liquid crystal layer LC, and the like. The switching element SW is constituted by a thin-film transistor (TFT), for example, and is electrically connected to the scanning line G and the signal line S. The pixel electrode PE is electrically connected to the switching element SW. The pixel electrodes PE of the pixels PX are each opposed to the common electrode CE. The liquid crystal layer LC is driven by an electric field produced between the pixel electrode PE and the common electrode CE. A storage capacitance CS is formed between, for example, an electrode having the same potential as that of the common electrode CE and an electrode having the same potential as that of the pixel electrode PE.

Further, details of the structure of the pixel PX are not explained here, but any one of a display mode using a longitudinal electric field produced along a normal of the substrate main surface, a display node using an oblique electric field which is tilted obliquely with respect to the substrate main surface, a display mode using a lateral electric field produced along the substrate main surface, and a display mode using an appropriate combination of the above longitudinal electric field, the lateral electric field, and the oblique electric field, may be applied to the pixel PX. The substrate main surface is a surface parallel to the X-Y plane defined by the first direction X and the second direction Y.

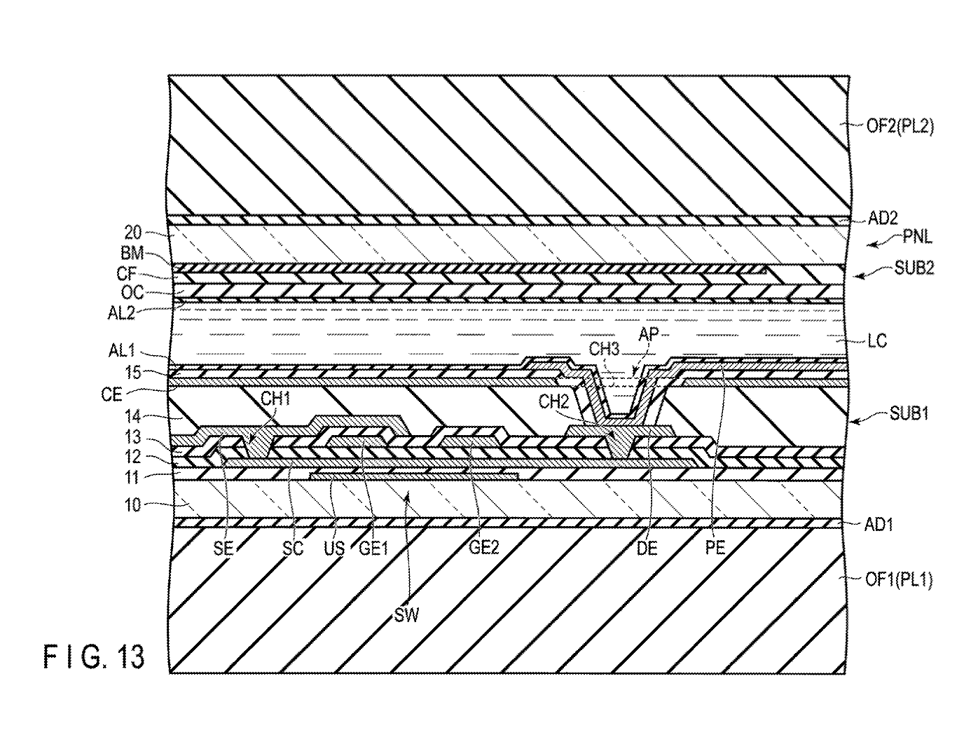

FIG. 13 is a cross-sectional view showing a configuration example of the pixel PX. The configuration example of the illustrated pixel PX corresponds to an example in which the display mode using the lateral electric field is applied.

The first substrate SUB1 includes an insulating substrate 10, insulating layers 11 to 15, a lower light-shielding layer US, a semiconductor layer SC, the switching element SW, the common electrode CE, the pixel electrode PE, and an alignment film AL1. The insulating substrate 10 is formed of a resin material such as polyimide, and is a substrate having flexibility and light transmissivity. The lower light-shielding layer US is located on the insulating substrate 10, and is covered with the insulating layer 11. The semiconductor layer SC is located on the insulating layer 11, and is covered with the insulating layer 12. The semiconductor layer SC is formed of, for example, polycrystalline silicon, but may be formed of amorphous silicon or an oxide semiconductor.

In the switching element SW, gate electrodes GE1 and GE2 are located on the insulating layer 12, and are covered with the insulating layer 13. The gate electrodes GE1 and GE2 are electrically connected to one of the scanning lines G shown in FIG. 12. Each of a source electrode SE and a drain electrode DE is located on the insulating layer 13, and is covered with the insulating layer 14. The source electrode SE is electrically connected to one of the signal lines S shown in FIG. 12. The source electrode SE is in contact with the semiconductor layer SC through a contact hole CH1 penetrating the insulating layers 12 and 13. The drain electrode DE is in contact with the semiconductor layer SC through a contact hole CH2 penetrating the insulating layers 12 and 13.

The common electrode CE is located on the insulating layer 14, and is covered with the insulating layer 15. The pixel electrode PE is located on the insulating layer 15, and is covered with the alignment film AL1. A part of the pixel electrode PE is opposed to the common electrode CE via the insulating layer 15. The common electrode CE and the pixel electrode PE are formed of a transparent conductive material such as indium-tin-oxide (ITO) or indium-zinc-oxide (IZO). The pixel electrode PE is in contact with the drain electrode DE through a contact hole CH3 penetrating the insulating layers 14 and 15 at a position overlapping an aperture AP of the common electrode CE. Note that each of the insulating layers 11 to 13 and the insulating layer 15 is an inorganic insulating layer made of, for example, silicon oxide, silicon nitride, or silicon oxynitride, and may have a single-layer structure or a multilayer structure. The insulating layer 14 is an organic insulating layer made of acrylic resin, for example.

The second substrate SUB2 comprises an insulating substrate 20, a light-shielding layer BM, a color filter layer CF, an overcoat layer OC, and an alignment film AL2. The insulating substrate 20 is formed of a resin material such as polyimide, and is a substrate having flexibility and light transmissivity. The light-shielding layer BM and the color filter layer CF are located on the insulating substrate 20 at the side opposed to the first substrate SUB1. The light-shielding layer BM can be formed together by using the same material as that used for the light-shielding layer LS shown in FIG. 1, etc. The light-shielding layer BM is disposed at a position opposed to each of line portions such as the signal lines S, the scanning lines G, and the switching element SW. The color filter layer CF is arranged at a position opposed to the pixel electrode PE, and a part of the color filter layer CF overlaps the light-shielding layer BM. The overcoat layer OC covers the color filter layer CF. The alignment film AL2 covers the overcoat layer OC.

The liquid crystal layer LC is located between the first substrate SUB1 and the second substrate SUB2, and is held between the alignment film AL1 and the alignment film AL2. The liquid crystal layer LC contains liquid crystal molecules. The liquid crystal layer LC is formed of a liquid crystal material of a positive type (positive dielectric anisotropy) or a negative type (negative dielectric anisotropy).

Next, a formation example of the grooves GR1 and GR2 will be explained.

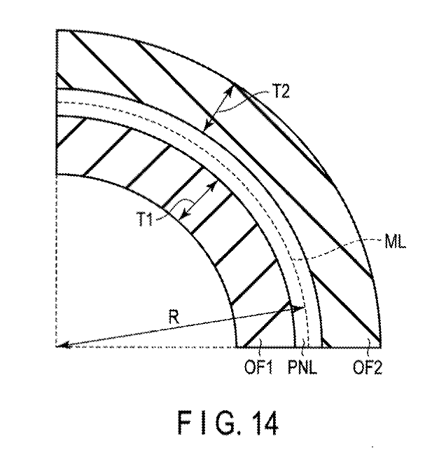

FIG. 14 is a cross-sectional view showing the state in which the first optical film OF1 and the second optical film OF2 are bent by 90 degrees together with the display panel PNL. Here, explanation will be given assuming that the thickness T1 of the first optical film OF1 is equal to the thickness T2 of the second optical film OF2, and a median line ML of the bending is at the display panel PNL. When a radius of curvature (i.e., a curvature radius) of the median line ML is represented as R, a length of the median line ML is defined as 2πR/4. Meanwhile, a length of the first optical film OF1 on the inner circumferential side is defined as 2π(R−T1)/4. Accordingly, a difference between the median line ML and the first optical film OF1 is calculated as (π*T1)/2. In other words, with the first optical film OF1 being bent by 90 degrees together with the display panel PNL, a length equivalent to (π*T1)/2 is a surplus. Accordingly, in the first optical film OF1, by forming the groove GR1 having a width of (π*T1)/2 or more, bending of the display panel PNL by 90 degrees can be facilitated. Similarly, in a state in which the display panel PNL is bent by 180 degrees, in the first optical film OF1, a length equivalent to (π*T1) is a surplus. Accordingly, by forming the groove GR1 having a width of (π*T1) or more, bending of the display panel PNL by 180 degrees can be facilitated.

In one example, when the curvature radius R is 200 μm, the length of the median line M1 represented as 2πR/4 is 314 μm. Also, when the thickness T1 of the first optical film OF1 is 100 μm, the length represented as (π*T1)/2 is approximately 157 μm. Accordingly, when the display panel PNL is to be bent by 90 degrees, a width of the groove GR1 in the first optical film OF1 should preferably be 157 μm or more.

Further, a length of the second optical film OF2 on the outer circumferential side is defined as 2π(R+T2)/4. Accordingly, a difference between the second optical film OF2 and the median line ML is calculated as (π*T2)/2. In other words, with the second optical film OF2 being bent by 90 degrees together with the display panel PNL, a length equivalent to (π*T2)/2 is insufficient. Accordingly, in the second optical film OF2, by forming the groove GR2 having a width of (π*T2)/2 or more, bending of the display panel PNL by 90 degrees can be facilitated. Similarly, in a state in which the display panel PNL is cent by 180 degrees, in the second optical film OF2, a length equivalent to (π*T2) is insufficient. Accordingly, by forming the groove GR2 having a width of (π*T2) or more, bending of the display panel PNL by 180 degrees can be facilitated.

In one example, when the thickness T2 of the second optical film OF2 in 100 μm, the length represented as (π*T2)/2 is approximately 157 μm. Accordingly, when the display panel PNL is to be bent by 90 degrees, a width of the groove GR2 in the second optical film OF2 should preferably be 157 μm or more.

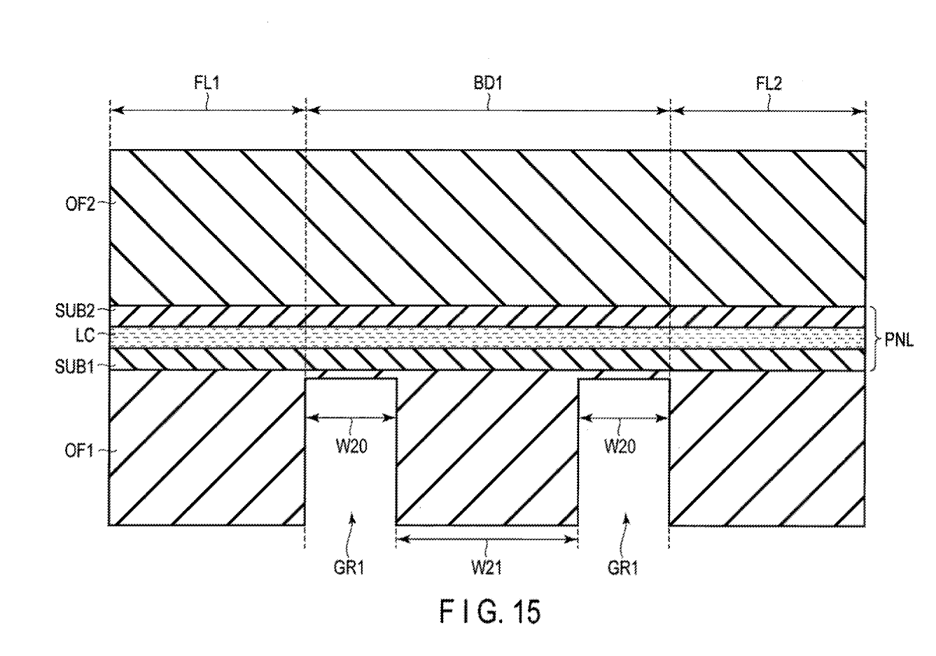

FIG. 15 is a cross-sectional view showing a formation example of the groove GR1. The illustrated formation example corresponds to an example in which the two grooves GR1 overlap the first bend portion BD1 being bent by 90 degrees, as shown in FIG. 9. The two grooves GR1 have the same width W20. A width of the first bend portion BD1 corresponds to the length of the median line ML explained with reference to FIG. 14, and is, for example, 314 μm. The width W20 of the groove GR1 is 78.5 μm, and a total sum of the widths W20 of the two grooves GR1 is 157 μm. In the example illustrated, the groove GR1 on one side has the width W20 from the boundary between the first flat portion FL1 and the first bend portion BD1, and the groove GR1 on the other side has the width W20 from the boundary between the first bend portion BD1 and the second flat portion FL2. A width W21 of the first optical film OF1 located between the two grooves GR1 is 157 μm.

Note that a depth of the groove GR1 may be equal to a depth of the first optical film OF1 in a case where the groove GR1 is penetrated through the first optical film OF1 as will be described later, or the depth may be of a level where a certain amount is left in the first optical film OF1. FIG. 15 illustrates a case where the first optical film OF1 is left with a certain thickness less than the thickness of the first flat portion FL1. The thickness of the first optical film OF1 to be left may be constant in all positions, or may be changed according to the position.

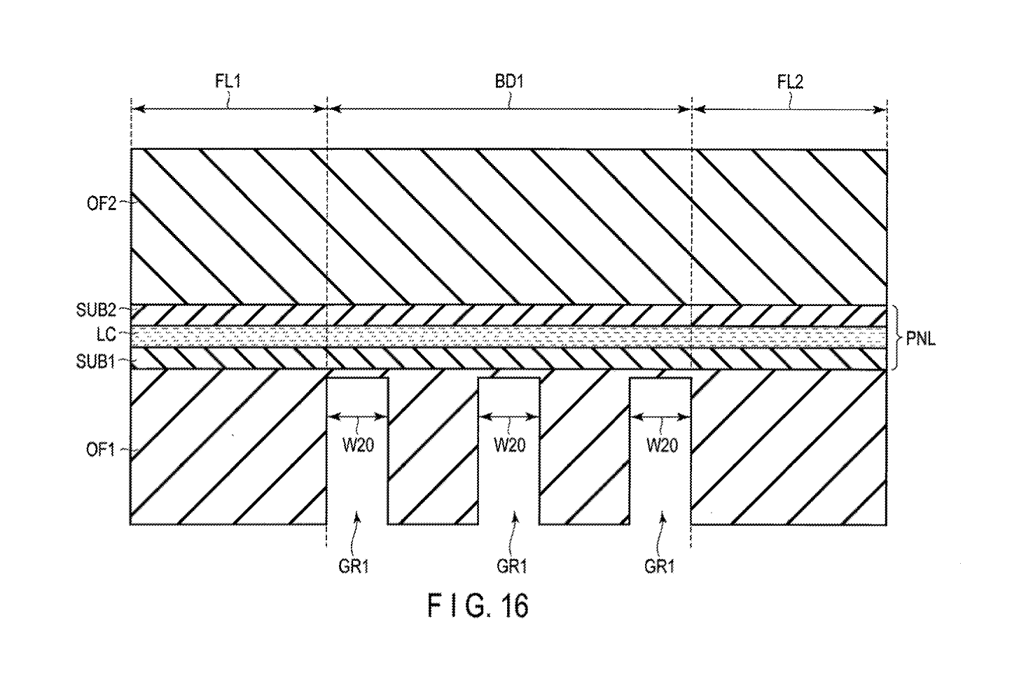

FIG. 16 is a cross-sectional view showing another formation example of the groove GR1. The formation example illustrated in FIG. 16 is different from the formation example illustrated in FIG. 15 in that three grooves GR1 overlap the first bend portion BD1. These three grooves GR1 are formed at regular intervals. The width W20 is 52 μm.

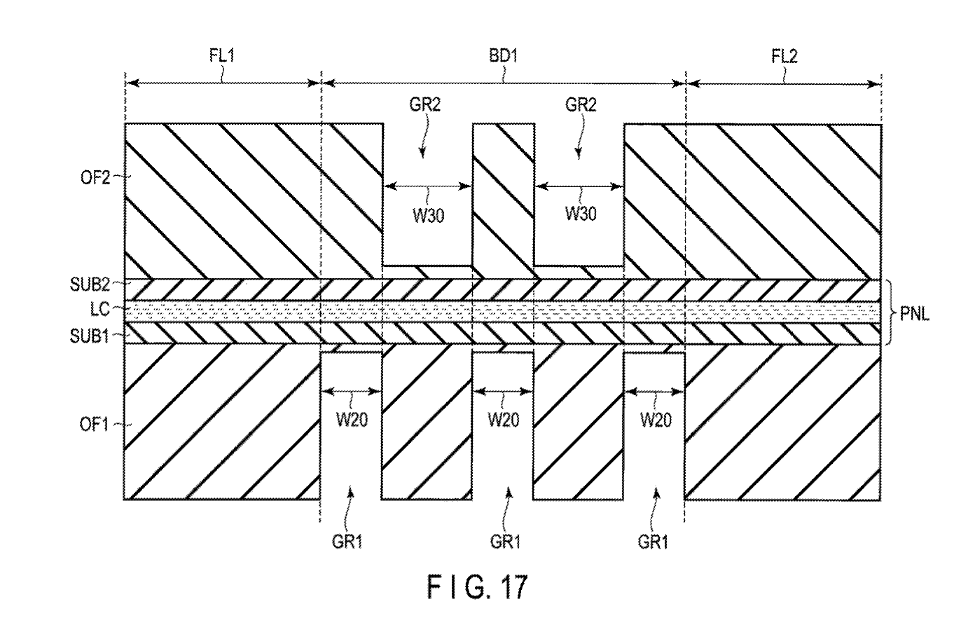

FIG. 17 is a cross-sectional view showing a formation example of the grooves GR1 and GR2. The formation example illustrated in FIG. 17 is different from the formation example illustrated in FIG. 16 in that two grooves GR2 overlap the first hand portion BD1. The two grooves GR2 have the same width W30. The width W30 of the groove GR2 is 78.5 μm, and a total sum of the widths W30 of the two grooves GR2 is 157 μm. The grooves GR2 are formed at positions not directly above the grooves GR1 so as not to overlap the grooves GR1. From the standpoint of suppressing deformation of the first bend portion BD1, preferably, the grooves GR1 and GR2 should not overlap one another.

In each of the formation examples shown in FIGS. 15 to 17, the width W20 of each of the grooves GR1 does not need to be the same in all of the grooves GR1, and preferably, a total sum of the widths W20 should be (π*T1)/2 or more for one bend portion. Similarly, the width W30 of each of the grooves GR2 does not need to be the same in all of the grooves GR2, and preferably, a total sum of the widths W30 should be (π*T2)/2 or more for one bend portion.

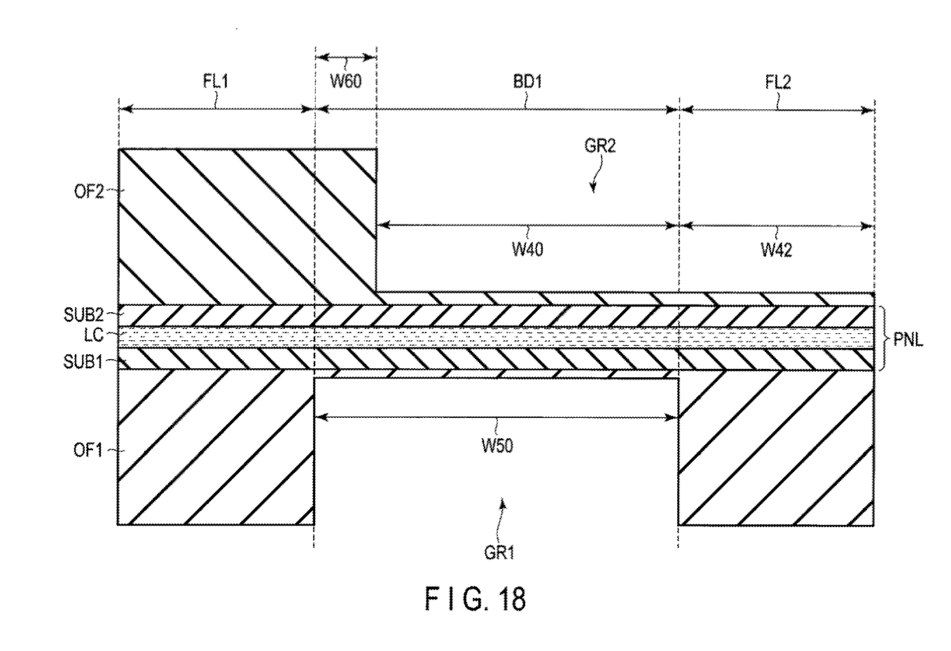

FIGS. 18 to 21 are cross-sectional views showing the other formation examples of the grooves GR1 and GR2. The formation example illustrated in FIG. 18 shows the case where the display panel PNL is bent by 90 degrees at the bend portion BD1, and the display panel PNL is opposed to the illumination device IL, etc., at the second flat portion FL2. Note that when the display panel PNL is bent by 180 degrees, as shown in FIG. 8, the display panel PNL is formed such that it is further bent by 90 degrees at the bend portion BD2, the third flat portion FL3 is opposed to a bottom surface of the illumination device IL, and the third flat portion FL3 is opposed to the first flat portion FL1.

The groove GR1 is formed for the entire width W50 of the bend portion BD1, and the groove GR2 is formed to have a width W40, with the second optical film OF2 having a width W60 left from the boundary (bend start point) between the first flat portion FL1 and the bend portion BD1, in the remaining bend portion BD. The width W60 from the bend start point of the second optical film OF2 is set in consideration of the joining accuracy when the second optical film OF2 and the first optical film OF1 are bonded together. If the joining accuracy is not considered, the width W60 may be set to 0, and the groove GR2 can be formed for the entire width W50 of the bend portion BD also in the second optical film OF2.

Note that when the display panel is to be bent by 90 degrees at the bend portion BD1 assuming that the thickness of each of the first optical film OF1 and the second optical film OF2 at the first flat portion FL1 is 100 μm, the width W50 of the groove GR1 is 314 μm, and the width W40 of the groove GR2 is 274 μm given that the width W60 is 40 μm. A width W42 of the second flat portion FL2 is 120 μm in FIG. 18, although this depends on a thickness of the illumination device IL, etc.

Alternatively, it is possible to achieve a structure in which the second substrate SUB2 is exposed by removing the second optical film OF2 for the width W40 at the bond portion BD1, and a structure in which the second substrate SUB2 is exposed by removing the second optical film OF2 for the width W42 at the second flat portion FL2.

The thickness of the first optical film OF1 is reduced for the entire width W50 at the bend portion BD1, and the thickness of the second optical film OF2 is reduced for the width W40 by leaving a part of the second optical film OF2 from the bend start point. As a result, when the first flat portion FL1 is seen in plan view, the thickness of the bend portion BD1 is equivalent to the thickness of the display panel PNL, and the width of a peripheral area of the display panel PNL can be greatly reduced as compared to a conventional structure.

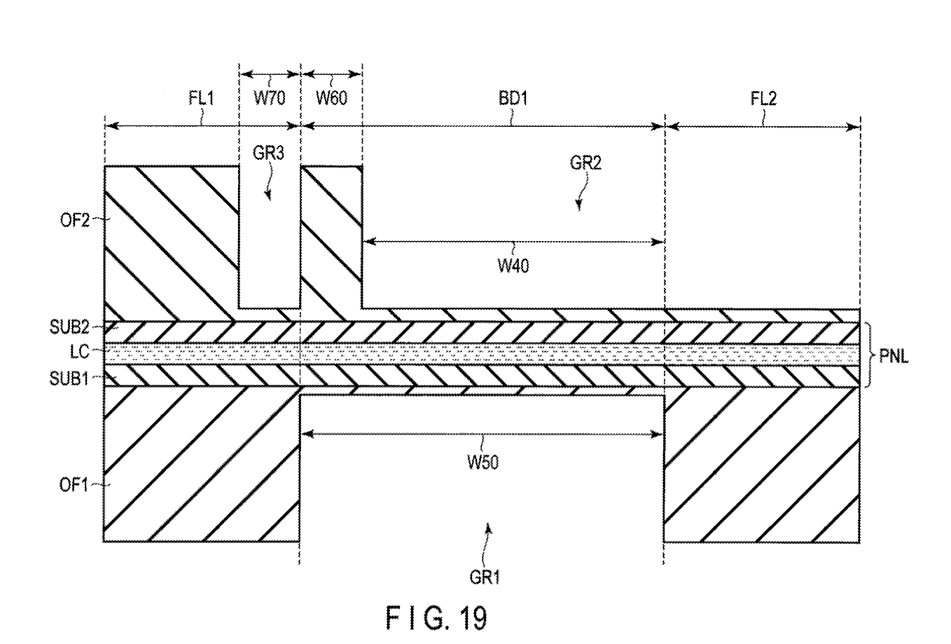

In a formation example illustrated in FIG. 19, a groove GR3 is formed in the first flat portion FL1 from the boundary between the first flat portion FL1 and the bend portion BD1. As the thickness of the second optical film OF2 is reduced immediately before the bend start point, the groove GR3 serves to allow the bending.

Also in FIG. 19, the groove GR1 is formed for the entire width W50 of the bend portion BD1, and the groove GR2 is formed to have the width W40, with the second optical film OF2 having the width W60 left from the boundary (bend start point) between the first flat portion FL1 and the bend portion BD1, in the remaining bend portion BD1. Note that a width W70 of the groove GR3 is 40 μm.

Since the groove GR3 shown in FIG. 19 is formed to allow bending of the display panel PNL, the depth of the groove GR2 and the depth of the groove GR3 do not need to be the same. However, in FIG. 19, the thickness of the second optical film OF2 is formed to be the same in the groove GR3 and the groove GR2.

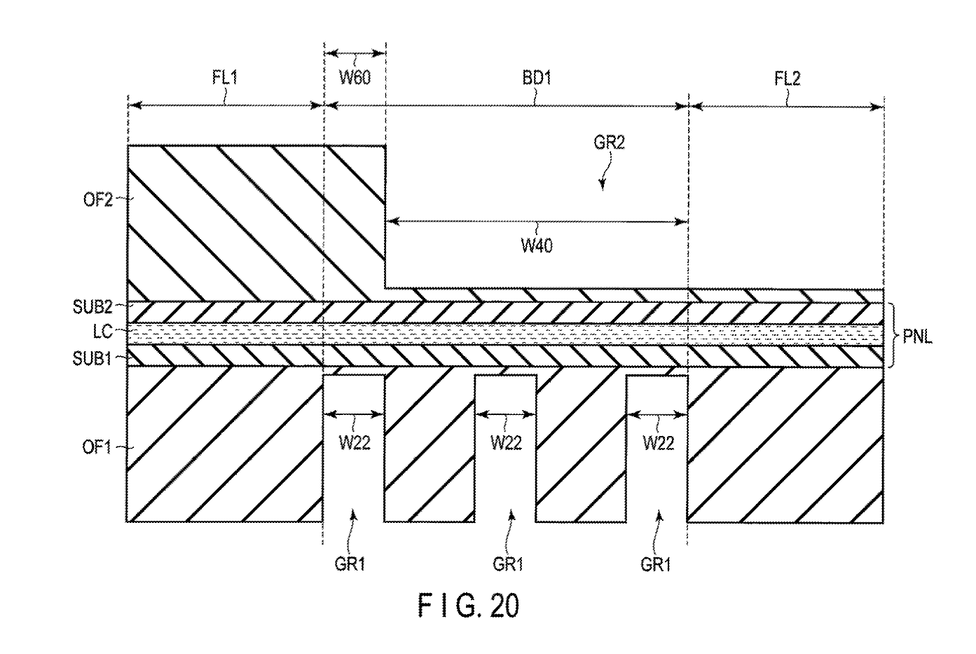

In a formation example illustrated in FIG. 20, the groove GR1 is formed at three places in spots at the bend portion BD1, and to have a width W22. When the first optical film OF1 having the width W50, which is the same as the first optical film OF1 in the formation example shown in FIG. 18, and the second optical film OF2 are applied, the width W22 of the groove GR1 in a case where the grooves GR1 are formed at three places is 52 μm. Note that the width W22 of the groove GR1 when the grooves GR1 are formed at two places is 78.5 μm. By forming the groove GR2 having the width W40, with the second optical film OF2 having the width W60 left from the boundary (bend start point) of the bend portion BD1, reducing the width of the peripheral area of the display panel PNL is enabled. In addition to this feature, by leaving a part of the first optical film OF1 of the bend portion BD1, the strength of the bend portion BD1 is maintained.

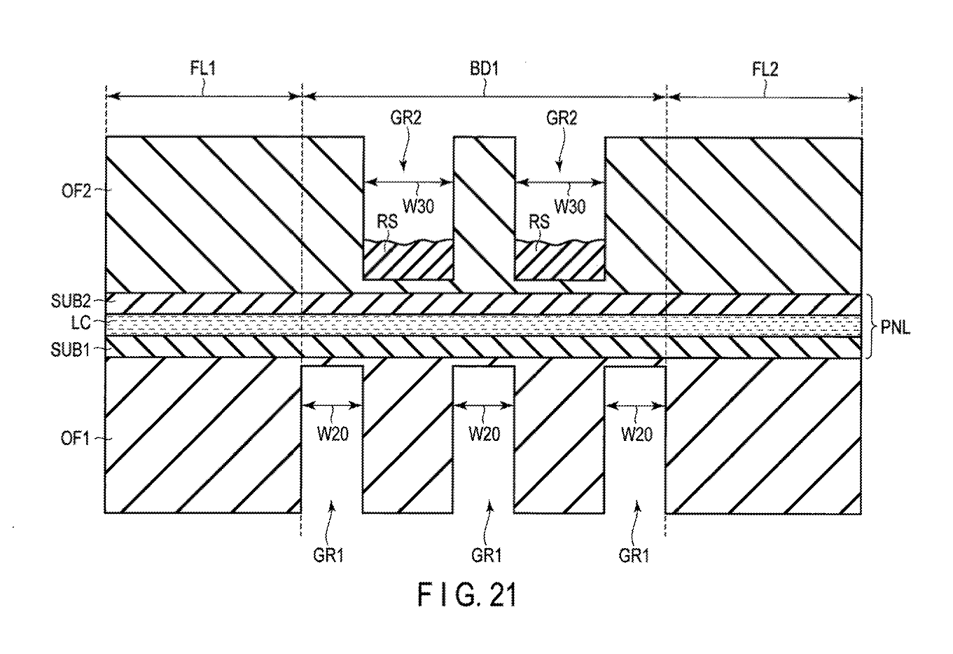

In a formation example illustrated in FIG. 21, a resin (for example, silicone resin) RS whose modulus of elasticity is lower than that of the second optical film OF2 is filled into the groove GR2 formed in the second optical film OF2. As compared to a case where the resin is not filled into the groove GR2, although the width of the peripheral area of the display panel PNL is increased, the strength of the bend portion BD is improved. The resin RS can also be filled into the groove GR1.

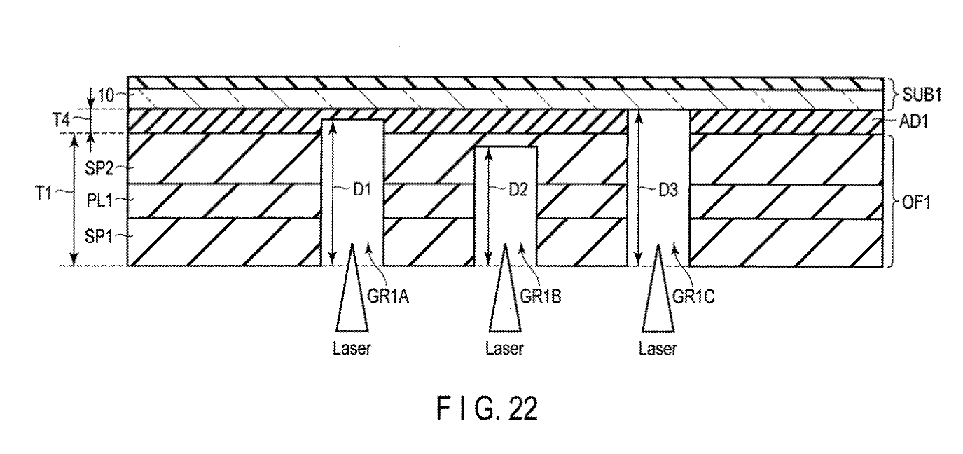

FIG. 22 is an illustration showing an example of the shape of the groove GR1. The first optical film OF1 comprises a pair of support bodies SP1 and SP2, and a polarizing layer PL1. The support bodies SP1 and SP2 are formed of, for example, triacetylcellulose (TAC) and cycloolefin polymer (COP). The polarizing layer PL1 is formed of, for example, polyvinyl alcohol (PVA). The polarizing layer PL1 is held between the support bodies SP1 and SP2. The support body SP2 is bonded to the insulating substrate 10 by the adhesive layer AD1.

A groove GR1A illustrated penetrates through the first optical film OF1, and exposes the adhesive layer AD1. In other words, a depth D1 of the groove GR1A is greater than the thickness T1 of the first optical film OF1, and less than a total sum of the thickness T1 and a thickness T4 of the adhesive layer AD1.

The groove GR1A is formed by applying a laser beam from the support body SP1 side. As a laser device which emits laser beams, a carbon dioxide laser device which emits laser beams of infrared wavelengths, or a solid laser device which outputs laser beams of ultraviolet wavelengths, for example, is applicable. An amount of removal of the first optical film OF1 can be adjusted in a range of several micrometers to ten micrometers by applying the laser beams multiple times separately, or controlling the power of the laser beams. For example, the adhesive layer AD1 has the thickness of 20 μm. Accordingly, the groove GR1A having the desired depth D1 in which an end portion of the groove GR1A is located in the adhesive layer AD1 can be formed.

The support bodies SP1 and SP2, and the polarizing layer PL1 are formed of a material having a high Young's modulus as compared to the adhesive layer AD1. Accordingly, as the groove GR1A penetrates through the first optical film OF1, bending of the display panel PNL including the illustrated first substrate SUB1 can be facilitated.

Although a groove GR1B penetrates through the support body SP1 and the polarizing layer PL1, the groove GR1B does not penetrate through the support body SP2. In other words, a depth D2 of the groove GR1B is less than the thickness T1 of the first optical film OF1. Even in a case where such a groove GR1B is formed, as compared to a case where a groove is not formed in the first optical film OF1, the bending of the display panel PNL can be facilitated.

A groove GR1C illustrated penetrates through the first optical film OF1 and the adhesive layer AD1, and exposes the insulating substrate 10. In other words, a depth D3 of the groove GR1C is equal to a total sum of the thickness T1 of the first optical film OF1 and the thickness T4 of the adhesive layer AD1. Even in a case where such a groove GR1C is formed, the bending of the display panel PNL can be facilitated.

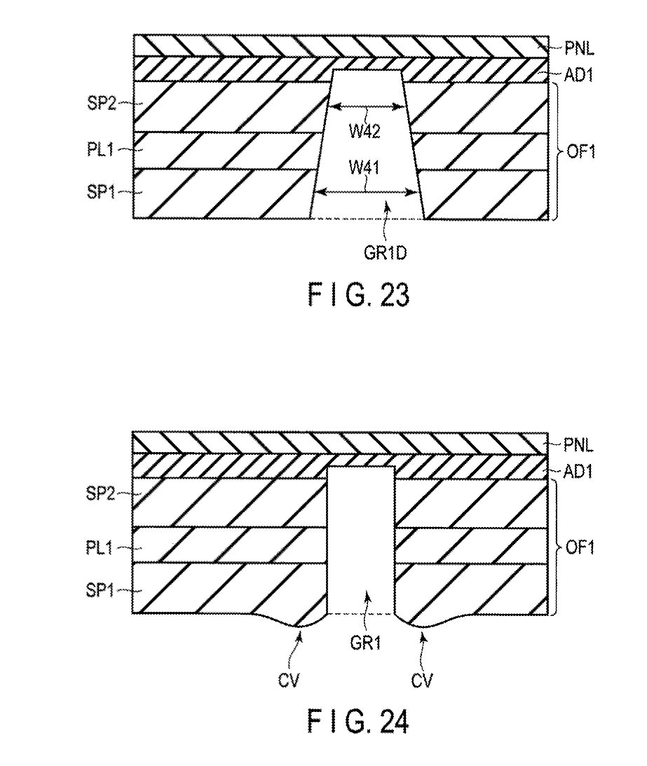

FIG. 23 is an illustration showing another example of the shape of the groove GR1. A groove GR1D illustrated is different from the groove GR1A shown in FIG. 22 in that the groove GR1D has a tapered cross section. In the groove GR1D, a first width W41 of a portion which penetrates the support body SP1 (in other words, a portion on a side distant from the display panel PNL) is greater than a second width W42 of a portion which penetrates the support body SP2 (in other words, a portion on a side close to the display panel PNL). The groove GR1D having such a cross section can be formed by applying a laser beam (Gaussian beam) having a beam profile of a Gaussian distribution to the first optical film OF1. Note that the groove GR1A having a rectangular cross section as shown in FIG. 22 can be formed by applying a laser beam having a square-wave-type beam profile to the first optical film OF1.

While the examples of the shapes of the groove GR1 have been explained with reference to FIGS. 22 and 23, the groove GR2 can have a similar shape.

FIG. 24 is an illustration showing another cross section of the first optical film OF1 comprising the groove GR1. A convex portion CV is formed on the periphery of the illustrated groove GR1. The convex portion CV is formed by a part of the support body SP1 which has been melted by the heat of a laser beam when the laser beam is applied to the first optical film OF1, and adhered to the periphery of the groove GR1. In other word, the convex portion CV constitutes a trace of formation of the groove GR1 by application of the laser beam.

As described above, according to the present embodiment, a display device in which the frame can be narrowed can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the present embodiment, a liquid crystal display device has been explained as an example of the display device. However, the display device is not limited to this. The main structures disclosed in the present embodiment are applicable to display devices such as a self-luminous display device with organic electroluminescent display elements and the like, an electronic paper-type display device with electrophoretic elements and the like, a display device employing micro-electromechanical systems (MEMS), and a display device employing electrochromism.

In the above, the display panel PNL of the present embodiment is a transmissive display panel having a transmissive display function of displaying an image by selectively passing light from a rear surface of the first substrate SUB1, but is not limited to this. The display panel PNL may either be a reflective display panel having a reflective display function of displaying an image by selectively reflecting light from a front surface of the second substrate SUB2, or a transflective display panel including both, the transmissive display function and the reflective display function. When the display panel PNL is of a reflective type, the illumination device IL as shown in FIG. 2 is omitted.

What is claimed is:

1. A display device comprising:
a display panel comprising a first flat portion, and a bend portion adjacent to the first flat portion; and
a first optical film comprising a first polarizing layer,
the first optical film comprising a first portion overlapping the first flat portion, and a second portion overlapping the bend portion,
a first thickness of the first portion being different from a second thickness of the second portion.

2. The display device of claim 1, wherein the second thickness is less than the first thickness.

3. The display device of claim 2, wherein:
the first optical film has a laminated structure in which the first polarizing layer is sandwiched between two support layers; and
the second thickness is less than a thickness of the support layer.

4. The display device of claim 2, wherein:
the first portion is bonded to the first flat portion by an adhesive layer; and
the second thickness is less than a thickness of the adhesive layer.

5. The display device of claim 2, wherein the second portion includes a groove extending along a boundary between the first flat portion and the bend portion.

6. The display device of claim 5, wherein the groove has a cross section in which a first width on a side distant from the display panel is greater than a second width on a side close to the display panel.

7. The display device of claim 5, wherein the first optical film includes convex portions on both sides of the groove.

8. The display device of claim 5, wherein the groove is formed along a short side of the display device.

9. The display device of claim 5, wherein the groove is formed along a long side of the display device.

10. The display device of claim 4, wherein:
the display panel further comprises a second flat portion located on a side opposite to the first flat portion;
the bend portion is located between the first flat portion and the second flat portion; and
the first optical film comprises a third portion bonded to the second flat portion by an adhesive layer.

11. The display device of claim 10, further comprising an illumination device located between the first flat portion and the second flat portion, wherein
the illumination device is opposed to the display panel,
the second portion is located between the illumination device and tho display panel.

12. The display device of claim 3, wherein the first optical film is bonded to the bend portion by an adhesive layer.

13. The display device of claim 3, wherein a width of the bend portion when the first flat portion is seen in plan view is less than a total sum of a thickness of the display panel and a thickness of the first optical film.

14. The display device of claim 13, wherein the second portion is located on an inner circumferential side of the bend portion.

15. The display device of claim 14, further comprising a second optical film comprising a second polarizing layer, wherein:
the display panel is located between the first optical film and the second optical film;
the second optical film comprises a third portion overlapping the first flat portion, and a fourth portion overlapping the bend portion; and
a fourth thickness of the fourth portion is less than a third thickness of the third portion.

16. The display device of claim 15, wherein each of the second portion and the fourth portion includes a groove extending along a boundary between the first flat portion and the bend portion.
